(19) United States
(12) Patent Application Publication
(10) Pub. No.: US 2015/0200885 A1
(43) Pub. Date: Jul. 16, 2015

(54) UNIFORM DISPLAY OF LINKED FILES AND ATTACHMENTS IN E-MAIL MESSAGES

(71) Applicant: GOOGLE INC., Mountain View, CA (US)

(72) Inventors: Phillip Sharp, Sunnyvale, CA (US); Joshua Hudgins, Lafayette, CO (US); Alon Shafrir, Kfar Saba (IL); James Michael McCollum, Brooklyn, NY (US)

(73) Assignee: GOOGLE INC.

(21) Appl. No.: 13/930,384

(22) Filed: Jun. 28, 2013

(51) Int. Cl. H04L 12/58

(52) U.S. Cl. CPC H04L 51/08

(57) ABSTRACT

A system and method for providing a display of attachments for an e-mail message includes receiving an e-mail message with a plurality of attachments at a server, where one of the attachments is a file and a second of the attachments is a link to a file provided by a third party service. A request from the e-mail server is sent to a thumbnail generation service to generate a preview thumbnail for each attachment, where each preview thumbnail has a uniform appearance. The e-mail message and the preview thumbnails generated by the thumbnail generation service are sent to a client computer for display.

### BACKGROUND

E-mail services allow users to send and receive e-mail messages over a remote network, such as the Internet. E-mail services may be provided by dedicated software programs installed on a user's computer, or may be online-based e-mail services accessible using a web browser. E-mail services allow senders to attach files to the e-mail message, in which a copy of the file is sent to the recipient along with the content of the e-mail message. Files that are stored on the computer that the sender is using, or stored within remotely maintained file folders that are accessible to the sender (e.g. via a local-area network or a wide-area network), may be attached in this manner. These attachments may be referred to as “local” file attachments. E-mail services may present the attachments to recipients in a number of ways. For example, if the file is an image the e-mail service may generate a preview thumbnail of the image and display it to the recipient so the recipient can see what the image depicts. For non-image attachments, the e-mail service may display icons corresponding to the attachment's file type, for example specific icons representing .pdf or .doc files. E-mail services usually display file attachments in a specific manner, for example in a special attachment section that is located below the content of the e-mail message. Recipients may identify all the attachments sent with the e-mail message by looking at the attachment section, and the attachment section may display the preview thumbnails or icons along with the name of the attachment and options for handling the attachments.

E-mail services also allow senders to insert uniform resource locator (URL) links into the e-mail message. The URL links may be links to specific web pages, but may also be links to files stored on a cloud computing service. Cloud computing services allow users to create, edit, and store files on a remote server and allow users to access the file from any computing device capable of connecting to the remote server. Each file is associated with a specific URL link generated by the cloud computing service. Thus inserting in an e-mail message a link to a file stored in a cloud computing service is similar to attaching a local file attachment. The recipient selects the URL link to view or download the file, for example using a web browser. The URL link is incorporated into the body of the e-mail message and does not appear in the attachment section. The e-mail service may display the bare URL link, or may use an icon or graphic to indicate it leads to a file stored on the cloud computing service. Senders may attach files to e-mail messages using both the local file attachment method and by including URL links to files provided by third party services, such as a cloud computing service. However, while both methods effectively attach files to the e-mail message, the e-mail service may treat and display these two methods differently. For example, links appear in the body of the e-mail message and may have certain options associated with them (e.g. open in new window), while local file attachments appear in the attachment section and have other options associated with them (e.g. download file). This may confuse recipients because the attachments are located in different parts of the e-mail message and are not displayed uniformly, and also because different options are available for different files depending on the method of attachment.

### SUMMARY

The systems and methods described herein provide a way for an e-mail service to provide a uniform display for attachments to an e-mail message, whether they are local file attachments or links to files provided by a third party service. An e-mail server receives an e-mail message sent by a sender, where the e-mail message contains local file attachments and links to files provided by a third party service. The third party service may be a cloud computing service and the link is to a file stored on the cloud computing service. Alternatively, the linked file may be a web page, image, video, map, interactive script, or any other electronic file that may be referenced by a URL link. The e-mail server communicates a thumbnail generation service to generate preview thumbnails for each attachment. The thumbnail generation service may be the cloud computing service storing the linked files. The cloud computing service sends the e-mail server preview thumbnails of the files that were linked in the e-mail message. The e-mail server also sends a copy of the local file attachments to the thumbnail generation service, which generates preview thumbnails of the file attachments and sends them back to the e-mail server. The e-mail server sends the e-mail message and the preview thumbnails for all the attachments to a recipient client computer for display. The preview thumbnails for all the attachments, whether by file or by link, have a uniform appearance, are displayed in the same manner and location in the e-mail message, and the same user options are made available for each attachment. Thus attachments made by both methods have an indistinguishable appearance to the recipient of the e-mail message.

One aspect described herein discloses a method for providing a display of attachments for an e-mail message, the method including receiving an e-mail message with a plurality of attachments at a server, where a first attachment in the plurality of attachments is a file and a second attachment in the plurality of attachments is a link to a file provided by a third party service. The method further includes sending a request to a thumbnail generation service to generate a preview thumbnail for each of the plurality of attachments, receiving from the thumbnail generation service the preview thumbnails for each of the plurality of attachments, where the preview thumbnail for each of the plurality of attachments have a uniform appearance, and sending the e-mail message and the preview thumbnails for the plurality of attachments to a client computer for display.

Another aspect described herein discloses a system for providing a display of attachments for an e-mail message, where the system includes a computing device. The computing device is configured to communicate with a plurality of client computers and a thumbnail generation service over a communication network, and receive an e-mail message with a plurality of attachments from a first client computer in the plurality of client computers, where a first attachment in the plurality of attachments is a file and a second attachment in the plurality of attachments is a link to a file provided by a third party service. The server is further configured to send a request to the thumbnail generation service to generate a preview thumbnail for each of the plurality of attachments, receive from the thumbnail generation service the preview thumbnails for each of the plurality of attachments, where the preview thumbnail for each of the plurality of attachments have a uniform appearance, and render the e-mail message and the preview thumbnails for the plurality of attachments for display.

Another aspect described herein discloses a graphical user interface for displaying attachments for an e-mail message. The graphical user display includes an e-mail message display for displaying the content of an e-mail message and an attachment preview area within the e-mail message display for displaying a plurality of preview thumbnails for a plurality of attachments in the e-mail message. A first attachment in the plurality of attachments is a file, a second attachment in the plurality of attachments is a link to a file provided by a third party service, and the plurality of preview thumbnails are generated by a thumbnail generation service and are displayed uniformly in the attachment preview area.

Another aspect described herein discloses a method for displaying attachments for an e-mail message. The method includes receiving an e-mail message with a plurality of attachments at a client computer, where a first attachment in the plurality of attachments is a file and a second attachment in the plurality of attachments is a link to a file provided by a third party service. The method further includes receiving a preview thumbnail for each of the plurality of attachments, where the preview thumbnails are generated by a thumbnail generation service and where the preview thumbnail for each of the plurality of attachments have a uniform appearance, and displaying the e-mail message and the preview thumbnails of the plurality of attachments to a recipient on the client computer.

### BRIEF DESCRIPTION OF THE DRAWINGS

The methods and systems may be better understood from the following illustrative description with reference to the following drawings in which:

FIG. 1 shows a number of client computers in communication with an e-mail server and a cloud computing service in accordance with an implementation as described herein;

FIG. 2 shows the components of an e-mail server in communication with a client computer in accordance with an implementation as described herein;

FIG. 3 shows a prior art example of a graphical user interface displaying an e-mail message;

FIG. 4 shows a graphical user interface displaying uniform attachments for an e-mail message in accordance with an implementation as described herein;

FIG. 5 shows a diagram for transmitting an e-mail message with uniform attachments to a recipient in accordance with an implementation as described herein;

FIG. 6 shows a method for providing a display of attachments for an e-mail message in accordance with an implementation as described herein; and

FIG. 7 shows a method for displaying attachments for an e-mail message in accordance with an implementation as described herein.

### DETAILED DESCRIPTION

To provide an overall understanding of the systems and methods described herein, certain illustrative embodiments will now be described, including systems and methods for providing a display of attachments for an e-mail message. However, it will be understood that the systems and methods described herein may be adapted and modified as is appropriate for the application being addressed and that the systems and methods described herein may be employed in other suitable applications, and that such other additions and modifications will not depart from the scope thereof. In particular, a server, service, or system as used in this description may be a single computing device or multiple computing devices working collectively and in which the storage of data and the execution of functions are spread out amongst the various computing devices.

Aspects of the systems and methods described herein relate to a uniform display of attachments in an e-mail message, where the attachments include local file attachments and links to files provided by a third party service. An e-mail server receives an e-mail message sent by a sender, where the e-mail message contains local attachments and links to files provided by a third party service. The third party service may be a cloud computing service and the link is to a file stored on the cloud computing service. Alternatively, the linked file may be a web page, image, video, map, interactive script, or any other electronic file that may be referenced by a URL link. The e-mail server communicates with a thumbnail generation service to generate preview thumbnails for each attachment. The thumbnail generation service may be the cloud computing service storing the linked files. In this case, the e-mail server sends the cloud computing service a copy of the local file attachments and information identifying the files included in the e-mail message by link. The cloud computing service is capable of generating preview thumbnails for most file types and sends the e-mail server preview thumbnails for all of the attachments. The e-mail server sends the e-mail message and the preview thumbnails for all of the attachments to a recipient client computer for display. The preview thumbnails for all of the attachments have a uniform appearance, are displayed in the same manner and location in the e-mail message display, and the same user options are made available for each attachment.

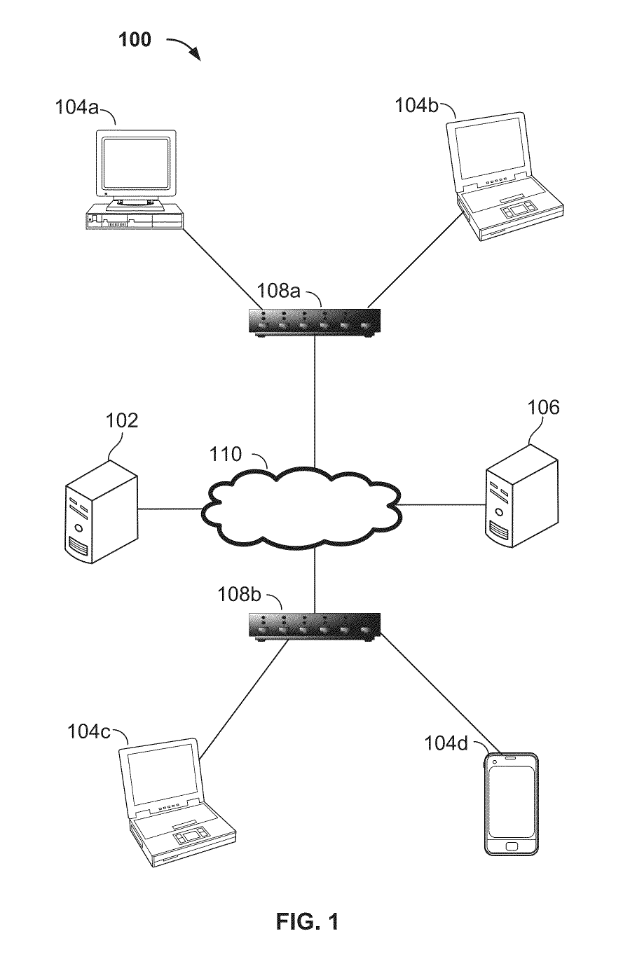

First, a network system in which a number of client computers may connect to an e-mail server and a third party service, such as a cloud computing service, is described. FIG. 1 shows a network system 100 that includes e-mail server 102, a number of client computers 104a through 104d, a cloud computing service 106, hubs 108a and 108b, and network 110. E-mail server 102 may include one or more servers that collectively provide network e-mail services for users on client computers 104a through 104d. For example, a user on client computer 104a may connect to e-mail server 102 over a remote network such as the Internet to access the user's e-mail account and send and receive e-mail messages. Cloud computing service 106 may include one or more servers that collectively provide cloud computing services for a number of client computers. Cloud computing service 106 stores a number of files accessible by client computers 104a-104d. Users may create, edit, copy, share, and delete files stored on cloud computing service 106. Each file stored on cloud computing service 106 is associated with a unique URL and this URL may be sent to other users to access the file. Client computers 104a-104d may include desktop computers, laptop computers, tablets, smart phones, mobile electronic devices, or any other device that may connect to e-mail server 102 and cloud computing service 106 through network 110. Hubs 108a and 108b may serve as local-area networks or other network subsystems that connect client computers to the greater network 110. For example, hub 108a may facilitate communication between client computers 104a and 104b and between all the devices that hub 108a services and network 110. System 100 may include many additional client computers not pictured in FIG. 1, and additional third party services that the client computers and e-mail server 102 may connect with. The network connection between the client computers 104a-104d, e-mail server 102, and cloud computing service 106 in network system 100 may be facilitated through a local area network, wide area network, Ethernet, fiber optic network, or any other wired or wireless connection.

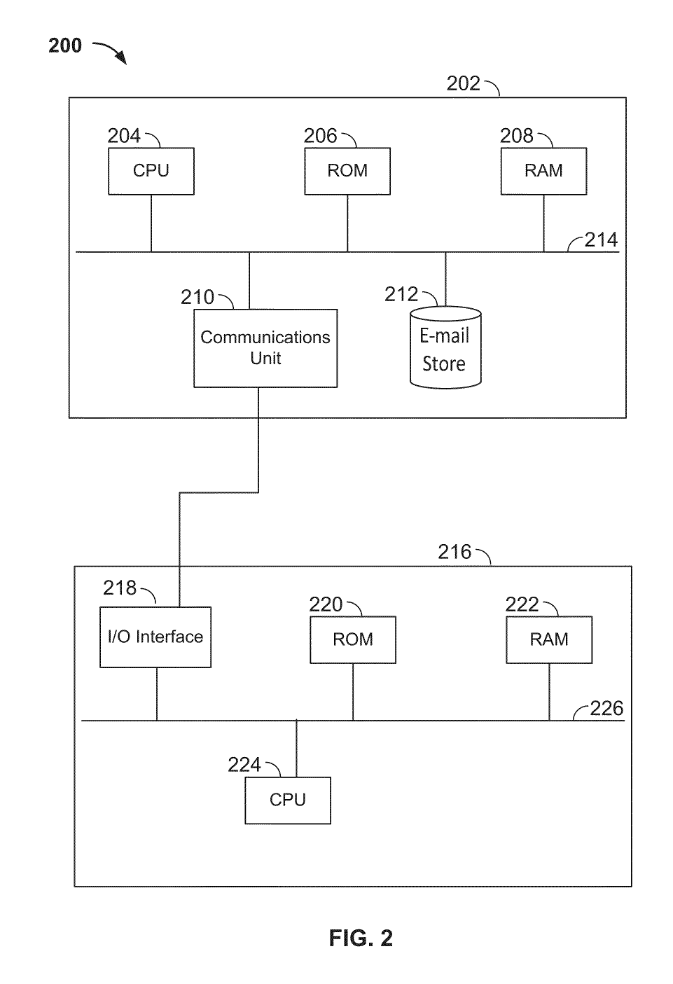

The components of a client computer and an e-mail server in communication with each other are now described in more detail. System 200 in FIG. 2 includes an e-mail server 202 in communication with a client computer 216. E-mail server 202 includes a central processing unit (CPU) 204, read-only memory (ROM) 206, random access memory (RAM) 208, communications unit 210, e-mail message store 212, and bus 214. E-mail server 202 may have additional components that are not illustrated in FIG. 2. Bus 214 allows the various components of e-mail server 202 to communicate with each other. Communications unit 210 allows e-mail server 202 to communicate with other devices, such as client computer 216 and other client computers, as well as third party services, such as a cloud computing service. E-mail message store 212 is used to store e-mail message data for a number of users, which may be accessed by users on client computers using a web browser. Users log on to the e-mail server using a username and password, and e-mail server 202 provides a user interface for the display of e-mail messages through the client computers' web browsers.

Client computer 216 includes a CPU 224, ROM 220, RAM 222, input/output interface 218, and bus 226. Client computer 216 may have additional components that are not illustrated in FIG. 2. Bus 226 allows the various components of client computer 216 to communicate with each other. Input/output interface 218 allows client computer 216 to communicate with other devices, such as e-mail server 202 and a third party service, such as a cloud computing service. Input/output interface 218 also includes devices for taking in user inputs and displaying outputs to a user, such as a keyboard, mouse, and display screen. CPU 224 executes various programs stored in memory on client computer 216, such as a web browser. Web browsers are used, among other things, to display a user interface provided by e-mail server 202 for viewing and composing e-mail messages.

E-mail message store 212 for e-mail messages stored on e-mail server 202, a web browser executing on client computer 216, and other data structures and software programs in system 200 may be implemented using non-transitory computer-readable media. Examples of suitable non-transitory computer-readable media include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and read-only, once-writable, or rewriteable CD-ROM and DVD-ROM disks.

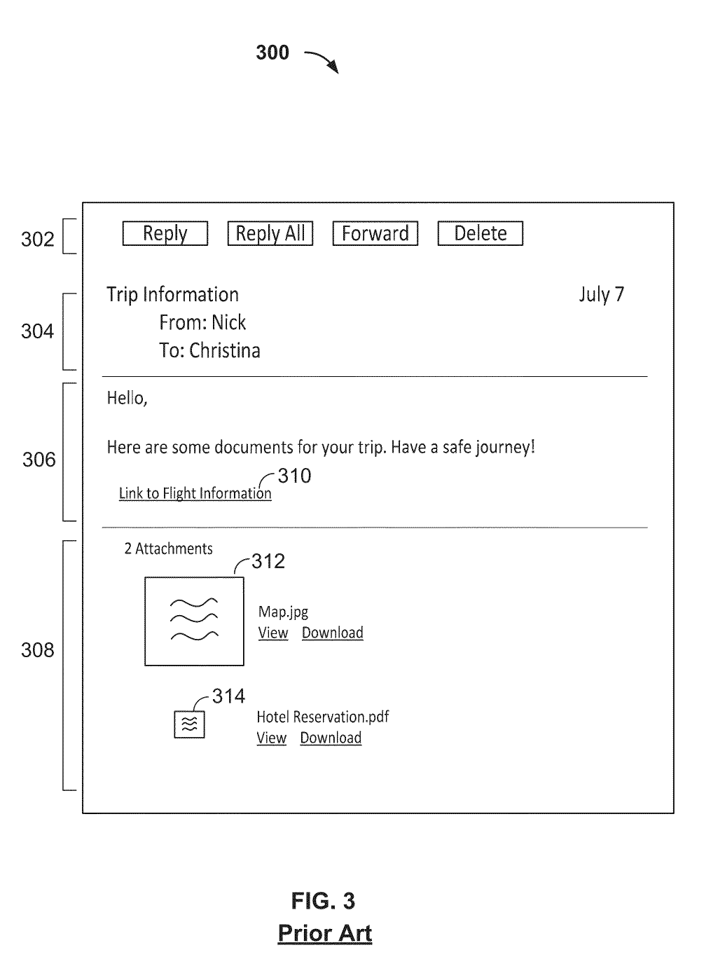

A typical previously known user interface for displaying an e-mail message is now described. FIG. 3 shows a user interface 300 provided by an e-mail server. User interface 300 may be displayed on a web browser executing on a client computer. A user on the client computer connects to the e-mail server using the web browser, logs into the user's account, and is able to view e-mail messages received by the user. User interface 300 includes command buttons 302 for applying commands to the presently viewed e-mail message, such as “Reply,” “Reply All,” “Forward,” “Delete,” and possibly other commands not illustrated in FIG. 3. User interface 300 also includes a header section 304 for displaying data about the e-mail message such as the name of the sender, the names of the recipients, the subject or title of the e-mail message, the date and time the e-mail message was sent, and other information not illustrated in FIG. 3. User interface 300 also includes an e-mail message body 306 for displaying the content of the e-mail message. The e-mail message body 306 may include text written by the sender of the e-mail message and also includes link 310. Link 310 is a link to a file provided by a third party service. Linked files may include files stored on a cloud computing service, or files, images, videos, maps, web pages, maps, interactive scripts, or any other electronic file accessible through a URL link. Link 310 may be shown as an underlined link, or may include an icon indicating that it is a link to a file provided by a third party service. User interface 300 may allow users only to select link 310, or may display certain user options for link 310, such as options to show a preview of the file or to open the file in a new browser window (options not shown in FIG. 3). User interface 300 also includes an attachment section or attachment “card” 308 for displaying file attachments to the e-mail message. Attachment 312 is a .jpg image file and a preview thumbnail of the attachment is shown in attachment card 308. Attachment 314 is a .pdf file and an icon is shown indicating that the attachment is a .pdf file type. Attachment card 308 displays user options for each attachment, including an option to view the attachment and an option to download the attachment. Other user options not shown in FIG. 3 may also be available to the recipient.

As seen from FIG. 3, the appearance of multiple attachments in a regular e-mail message display is not uniform. Attachments that are links to files provided by third party services, such as link 310, appear in a different section of the e-mail message from file attachments 312 and 314. Attachment 312 has a preview thumbnail because it is an image, but link 310 and attachment 314 do not. Attachment 314 has an icon representing its file type, but an icon may not be displayed for link 310. The size of the preview thumbnail for attachment 312 is large compared to the size of the icon for attachment 314. The user options available for attachments 312 and 314 also differ from the user options available for link 310. Overall, the appearance of user interface 300 is cluttered and unappealing, and attachments to the e-mail message are spread throughout the interface.

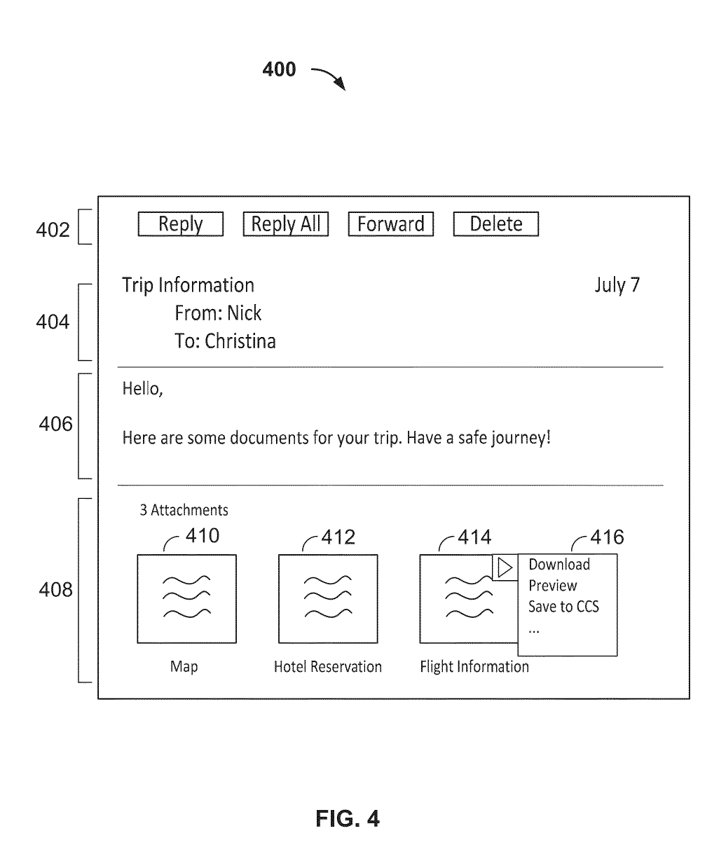

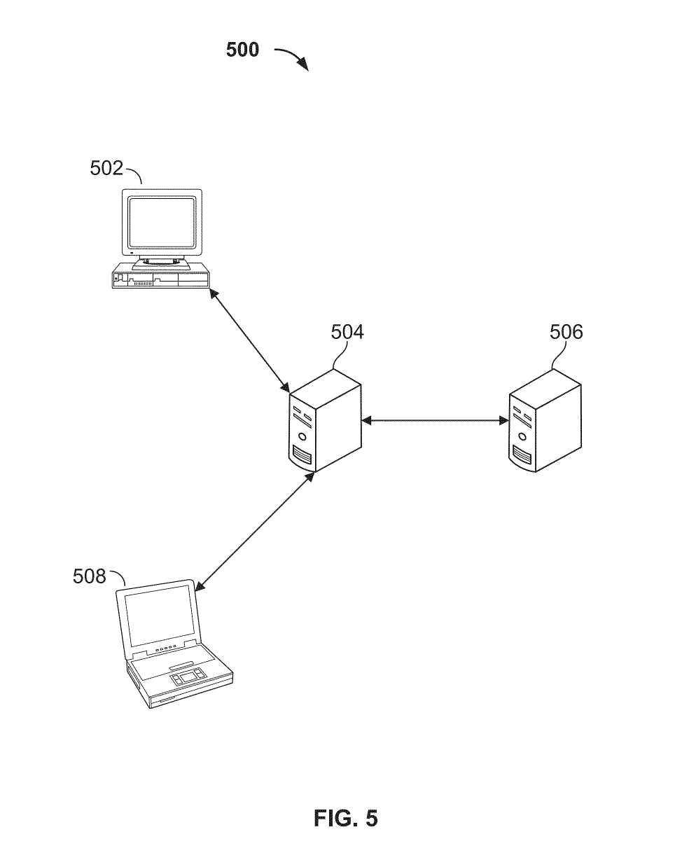

The systems and methods described herein offer an improvement to the typical e-mail message display shown in FIG. 3. Because links to files stored on a third party service are effectively attachments, the links should be treated and displayed in a similar manner to local file attachments. Also, it is beneficial to provide preview thumbnails for all attachments rather than only some attachments. In addition, similar user options should be available for all attachments. FIG. 4 shows a user interface 400 for an e-mail message similar to the user interface illustrated in FIG. 3 and incorporating the improvements described herein. User interface 400 includes command buttons 402 for applying commands to the presently viewed e-mail message, such as “Reply,” “Reply All,” “Forward,” “Delete,” and possibly other commands not illustrated in FIG. 4. User interface 400 also includes a header section 404 for displaying data about the e-mail message such as the name of the sender, the names of the recipients, the subject or title of the e-mail message, the date and time the e-mail message was sent, and other information not illustrated in FIG. 4. User interface 400 also includes an e-mail message body 406 for displaying the content of the e-mail message. The sender of the e-mail message has included a link in the body of the e-mail message to a file provided by a third party service, but user interface 400 does not display the link in e-mail message body 406. This is unlike FIG. 3, where link 310 is displayed in e-mail message body 306. Rather, in user interface 400 the link is incorporated as an attachment 414 in attachment card 408 along with file attachments 410 and 412. Each attachment includes its file name and a preview thumbnail associated with it. The preview thumbnails may all have the same size so that the display of the attachments is uniform within attachment card 408. Each attachment may be spaced equally apart, and the name, memory size, and other information about each attachment may be displayed along with the preview thumbnail. Other ways to render the attachments to appear uniform include having the same visual treatment, such as colors, tints, borders, fonts, iconography, text size, description of each attachment, and same menu options for handling the attachments. The attachments may be oriented horizontally as shown in FIG. 4, or may be oriented in any other fashion. The preview thumbnails are generated by a thumbnail generation service, such as a cloud computing service, which will be described in more detail in connection with FIG. 5.

User interface 400 provides an options menu 416 for each attachment in attachment card 408. Options menu 416 may appear when the recipient selects or points to the preview thumbnail, or when the recipient clicks on a drop-down arrow that appears when the recipient selects or points to the preview thumbnail, or any other method for providing menu options. Options menu 416 includes a number of options for handling the attachment, such as downloading a copy of the attachment onto the client computer, opening the attachment, printing the attachment, playing a video or audio attachment, or sharing or forwarding the attachment to someone else. Options menu 416 may also include an option to preview the attachment, which may open a new window or a Javascript overlay on top of user interface 400 for viewing a preview of the attachments. Options menu 416 may also include an option to save the attachment onto a cloud computing service, which when selected would save a copy of the attachment in the recipient's account on the cloud computing service. The recipient may be prompted to start an account if he or she does not already have an account on the cloud computing service. Many other saving, viewing, and sharing options also may be available to the recipient through options menu 416. The layout of user interface 400 is not restricted to that illustrated in FIG. 4, but may encompass other layouts. Specifically, attachment card 408 may be arranged in various layouts but each attachment, whether a file or a link, appears uniformly within attachment card 408.

Attachment card 408 may include preview thumbnails for all kinds of links to third party services normally embedded in e-mail message body 406, including files stored on a cloud computing service, web pages, images, videos, maps, interactive scripts, or other electronic files accessible through a URL link. For example, if a sender includes a link to an online video in the e-mail message, attachment card 408 may include a preview thumbnail of the video. If the sender includes a link to an online map showing directions or a specific location, attachment card 408 may include a preview thumbnail of the map. If the sender includes a link to an online photo album, attachment card 408 may include a preview thumbnail of the photo album. Options menu 416 would include additional options to handle the above-mentioned attachments, such as playing the video, bringing up the map, initiating GPS functions on the client computer using the map, or viewing the photo album. Other links that a sender may embed in the e-mail message may be depicted in attachment card 408. E-mail message body 406 may include inline images, which remain in the body of the e-mail message but the preview thumbnail for inline images may have the same dimensions as the preview thumbnails for the attachments and the same menu options may be available for in-line images. The uniform display of layouts may also be provided to a person sending an e-mail message. A user interface for composing an e-mail message may include an attachment card similar to attachment card 408 shown in FIG. 4. When the sender adds an attachment to the e-mail message, a preview thumbnail is generated for that attachment and the preview thumbnail is shown in the attachment card.

The process for generating preview thumbnails for attachments in e-mail messages is now described. System 500 in FIG. 5 depicts a process for delivering an e-mail message to a recipient where preview thumbnails are generated for all attachments in the e-mail message, whether a file attachment or a link to a file provided by a third party service. The third party service in this example is a cloud computing service, but the third party service may be any service that provides electronic files via a URL link, including images, videos, maps, interactive scripts, and web pages. A sender on client computer 502 drafts an e-mail message to a recipient, where the e-mail message includes one or more local file attachments and one or more links to files stored on cloud computing service 506. Once finished, the sender sends the e-mail message, which is transmitted over a remote network to recipient's e-mail server 504. E-mail server 504 scans the e-mail message and detects the presence of local file attachments. E-mail server 504 then parses the metadata information for each local file attachment, such as the name of the file, the file type, and the memory size. E-mail server 504 also parses the body of the e-mail message for the presence of links and determines that cloud computing service 506 stores the files corresponding to the links. For example, links to files stored by cloud computing service 506 may have a specific format or character string and e-mail server 504 detects that format.

E-mail server 504 communicates with a thumbnail generation service to help generate thumbnails for all the local file attachments and linked files in the e-mail message. The thumbnail generation service may be the cloud computing service 506 itself. E-mail server 504 may first check whether it has already obtained the preview thumbnails for one or more attachments in the e-mail message. For example, the recipient may have received the same attachments from multiple senders, or an e-mail message chain incorporating past messages may also incorporate attachments included in past messages. E-mail server 504 may have cached the thumbnails for those attachments and does not need to have cloud computing service 506 generate them again. E-mail server 504 may check the content signatures for each attachment, for example the hash value of the file content, to determine if a preview thumbnail has previously been generated for that attachment.

For new attachments, e-mail server 504 requests from a thumbnail generation service preview thumbnails for all the linked files and local file attachments in the e-mail message. The thumbnail generation service may be cloud computing service 506, which retrieves preview thumbnails for the linked files and generates preview thumbnails for the local file attachments. Alternatively, e-mail server 504 may request preview thumbnails of linked files from cloud computing service 506 and preview thumbnails of local file attachments from a separate thumbnail generation service. Alternatively, a thumbnail generation service separate from cloud computing service 506 may generate preview thumbnails for both linked files and local file attachments.

For example, if cloud computing service 506 is the sole thumbnail generation service, e-mail server 504 sends the request for preview thumbnails to cloud computing service 506. Cloud computing service 506 receives the request and may verify that the recipient is allowed to access the files linked in the e-mail message, for example by checking the access control list for each file. If the recipient is not authorized to access the file, cloud computing service 506 may return no thumbnail to e-mail server 504. Cloud computing service 506 usually stores preview thumbnails for all files stored on the service, for example in a thumbnail database maintained by the cloud computing service. The thumbnails for the linked files are identified and sent to e-mail server 504. E-mail server 504 also sends a copy of each local file attachment to cloud computing service 506. Cloud computing service 506 is configured to generate preview thumbnails for most file types and so generates a preview thumbnail for each file received from e-mail server 504. The preview thumbnails are sent back to e-mail server 504. If cloud computing service 506 cannot generate a preview thumbnail for certain files, it may return a generic icon to e-mail server 504. The preview thumbnails may be a standard image format, such as .gif or .jpg, and may all have the same dimensions. For certain file types, e-mail server 504 may use another thumbnail generation service other than cloud computing service 506 to generate the preview thumbnails. For example, for certain image formats e-mail server 504 may send a copy of the images to a dedicated image processing service to generate the preview thumbnail.

After the e-mail server 504 obtains preview thumbnails for all of the attachments in the e-mail message, whether a file attachment or a linked file, e-mail server 504 provides the e-mail message to the recipient on client computer 508 when the recipient checks his or her e-mail messages. E-mail server 504 provides a user interface for viewing e-mail messages, for example on a web browser executing on client computer 508. The user interface provided by e-mail server 504 displays all the attachments in the e-mail message, whether a file attachment or a linked file, uniformly. For example, the user interface may include an attachment card section that displays the preview thumbnails for all the attachments, such as user interface 400 in FIG. 4. The process of obtaining the preview thumbnails for the attachments is not instantaneous, so the user interface displaying the e-mail message may initially insert placeholder icons in the attachment card section while the preview thumbnails are being generated. When the preview thumbnails have been generated, the preview thumbnail may be faded in on top of the placeholder icon. Other methods of integrating newly generated preview thumbnails into the user interface may be used as well. E-mail server 504 may cache the preview thumbnails for a period of time so that it does not have to communicate with cloud computing service 506 every time the recipient views the e-mail message. Thus in this manner, e-mail server 504 and cloud computing service 506 work together to provide a uniform display of all attachments in an e-mail message.

An example pseudo-code of the process of providing a uniform display of all attachments in an e-mail message is shown below. This pseudo-code or variations of this pseudo-code may be performed by an e-mail server such as e-mail server 504 shown in FIG. 5.
1. E-mail server receives an e-mail message with local file attachments and linked files provided by a third party service.
2. E-mail server parses metadata of local file attachments.
3. E-mail server parses e-mail message text for linked files.
4. E-mail server checks content signature of attachments to identify attachments with previously cached preview thumbnails.
5. E-mail server communicates with thumbnail generation service and sends a copy of local file attachments and information identifying the linked files.
6. Thumbnail generation service returns preview thumbnails for all attachments.
7. E-mail server renders e-mail message on user interface of client computer, incorporating the preview thumbnails as they are received.
8. E-mail server caches the preview thumbnails and other metadata for future use.
   Although the pseudo-code shown above is performed on an e-mail server, it may easily be adapted to be performed on a client computer. That is, the client computer may be configured to perform the process of communicating with the thumbnail generation service to generate the preview thumbnails.

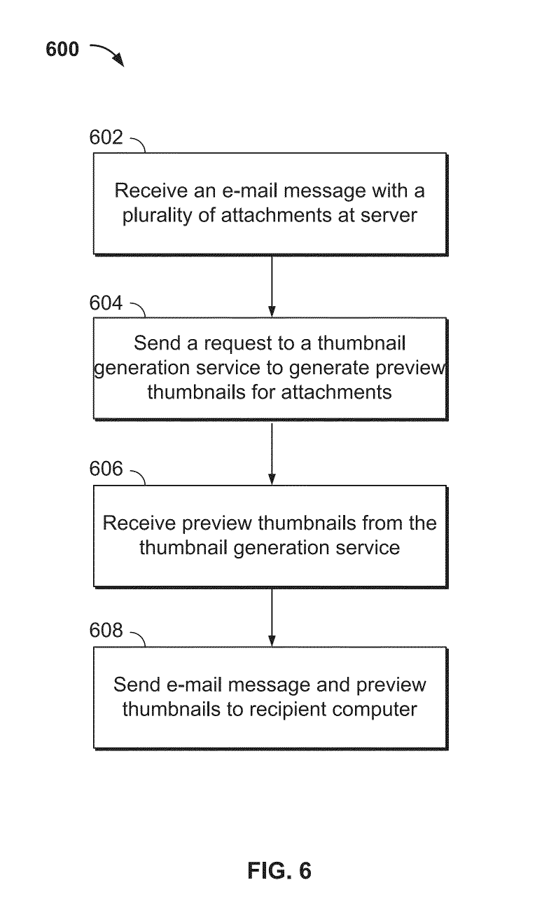

A method for providing a display of attachments for an e-mail message is now described. Method 600 illustrated in FIG. 6 includes receiving an e-mail message with a plurality of attachments at a server, where a first attachment in the plurality of attachments is a file and a second attachment in the plurality of attachments is a link to a file provided by a third party service. The method further includes sending a request to the cloud computing service to generate a preview thumbnail for each of the plurality of attachments and receiving from the cloud computing service the preview thumbnails for each of the plurality of attachments, where the preview thumbnail for each of the plurality of attachments have a uniform appearance. The method further includes sending the e-mail message and the preview thumbnails for the plurality of attachments to a client computer for display. Method 600 may be performed by an e-mail server such as server 202 in FIG. 2 or server 504 in FIG. 5.

Method 600 begins when a server receives an e-mail message with a number of attachments, illustrated at 602. The e-mail message is intended for a recipient whose e-mail account the server hosts. The attachments include both local file attachments and URL links to files provided by a third party service. The link may be a file stored on a cloud computing service, or may be any electronic file accessible through a URL link, such as web pages, images, videos, interactive scripts, and maps. The server parses the metadata of the local file attachments and the e-mail text to identify the linked files. The server analyzes the format of the links to determine which third party service the files are stored on. The server then sends a request to a thumbnail generation service to generate preview thumbnails for each attachment, illustrated at 604. The thumbnail generation service may be a cloud computing service storing the linked files. If the server sends the request to the cloud computing service, the request includes information identifying the linked files, for example document ID numbers, and copies of the local file attachments in the e-mail message. The server may also send the cloud computing service information identifying the recipient of the e-mail message, for example the recipient's e-mail address. The server may also send the cloud computing service other links included in the e-mail message, such as map or video links. The server may first check whether its cache stores preview thumbnails for any of the attachments, for example by checking the content signature of the attachments. If a preview thumbnail has previously been generated for the attachment, the server retrieves the preview thumbnail from its cache.

The cloud computing service is configured to generate preview thumbnails for most file types. The cloud computing service may have a thumbnail database for storing preview thumbnails for files stored on the cloud computing service. When the cloud computing service receives the preview thumbnail request from the server, it generates and returns preview thumbnails for each attachment, whether a file attachment or a linked file. For linked files, the cloud computing service identifies the files linked in the e-mail message. The cloud computing service obtains the preview thumbnails for those files from its thumbnail database and sends the thumbnails to the server. The cloud computing service may check whether the recipient is authorized to access the files, for example by checking the access control list for each file. If the recipient is not authorized to access a file, the cloud computing service may return no thumbnail for that file or return a generic thumbnail indicating that access is denied. The e-mail server would indicate to the recipient that access to the file is denied, but may still provide certain information such as the title and the file type. For file attachments sent by the server, the cloud computing service generates preview thumbnails for each file and returns them to the server. If the cloud computing service cannot generate thumbnails for a specific file type (e.g. uncommon proprietary files), the cloud computing service may provide a generic icon thumbnail to the server. The server may obtain preview thumbnails for certain file types from other services in lieu of the cloud computing service. For other types of links, such as links to online maps or videos, the cloud computing service may capture a preview thumbnail from the linked URL and send the thumbnails to the server. Preview thumbnails may be formatted in .gif, .jpg, or other known image formats. The preview thumbnails have a uniform appearance, such as having uniform dimensions, spacing, fonts, colors, borders, descriptions, and the like.

The server receives the preview thumbnails for each attachment, shown at 606. When the recipient next views the e-mail message, the server sends the e-mail message and the preview attachments to the recipient's client computer for display, shown at 608. The server may provide the client computer with a user interface for displaying the e-mail message, such as user interface 400 in FIG. 4. The user interface may be displayed on a web browser on the client computer. All the attachments to the e-mail message are shown in the same area of the user interface, such as an attachment section or card at the bottom of the e-mail message display. The preview thumbnails for all attachments are displayed uniformly such that there no visual differences between attachments that are local file attachments and linked file attachments. The user interface may provide a number of options for each attachment, such as saving the file to a cloud computing service, downloading the file, and previewing the file. The preview thumbnails may be cached for quick reference in the future. Thus method 600 illustrates a method for providing a uniform display of attachments in an e-mail message.

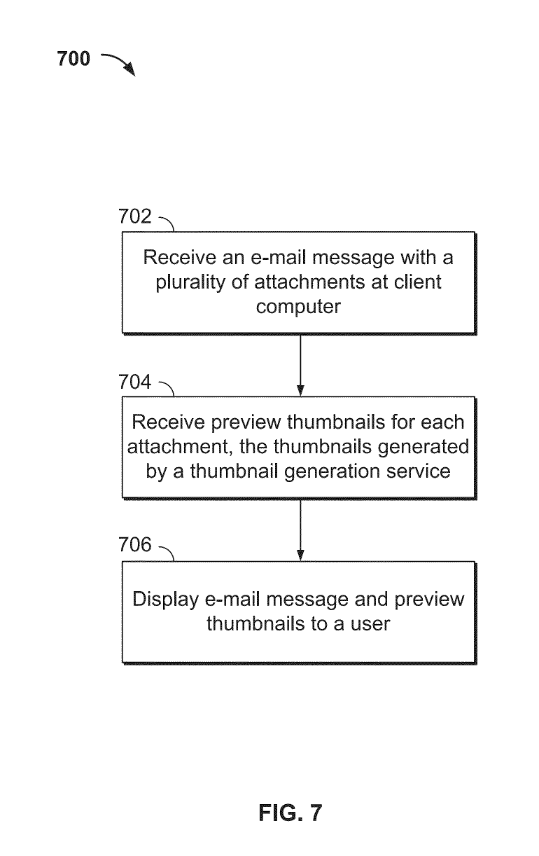

A method for displaying attachments for an e-mail message is now described. Method 700 illustrated in FIG. 7 includes receiving an e-mail message with a plurality of attachments at a client computer, where a first attachment in the plurality of attachments is a file and a second attachment in the plurality of attachments is a link to a file provided by a third party service. The method further includes receiving a preview thumbnail for each of the plurality of attachments, where the preview thumbnails are generated by the cloud computing service and where the preview thumbnail for each of the plurality of attachments have a uniform appearance, and displaying the e-mail message and the preview thumbnails of the plurality of attachments to a recipient on the client computer. Method 700 may be performed by a client computer such as client computer 216 in FIG. 2 or client computer 508 in FIG. 5.

Method 700 begins when a client computer loads an e-mail message with a plurality of attachments from an e-mail server, illustrated at 702. A recipient of the e-mail message uses the client computer to view e-mail messages received at the recipient's e-mail account handled by the e-mail server. The recipient may use a web browser to view the e-mail message, where the e-mail server provides the web browser with a user interface to display the e-mail such as user interface 400 in FIG. 4. The e-mail message includes a number of attachments, some of which are local file attachments and some of which are links to files provided by a third party service. The link may be a file stored on a cloud computing service, or may be any electronic file accessible through a URL link, such as web pages, images, videos, interactive scripts, and maps. The client computer also receives preview thumbnails for each attachment in the e-mail message, illustrated at 704. The preview thumbnails are generated by a thumbnail generation service. The e-mail server may communicate with the thumbnail generation service to generate the thumbnails, or the client computer may communicate directly with the thumbnail generation service to generate the thumbnails. The thumbnail generation service may be a cloud computing service storing one or more linked files.

The cloud computing service is configured to generate preview thumbnails for most file types. The cloud computing service may have a thumbnail database for storing preview thumbnails for files stored on the cloud computing service. The e-mail server or client computer sends a preview thumbnail request to the cloud computing service for each attachment, whether a file attachment or a linked file. For linked files, the cloud computing service identifies the files linked in the e-mail message. The cloud computing service obtains the preview thumbnails for those files from its thumbnail database and sends the thumbnails to the e-mail server or client computer. The cloud computing service may check whether the recipient is authorized to access the files, for example by checking the access control list for each file. If the recipient is not authorized to access a file, the cloud computing service may return no thumbnail for that file or return a generic thumbnail indicating that access is denied. The e-mail server or client computer would indicate to the recipient that access to the file is denied, but may still provide certain information such as the title and the file type. The e-mail server or client computer also sends a copy of each file attachment to the cloud computing service, which generates preview thumbnails for each file and returns them to the e-mail server or client computer. If the cloud computing service cannot generate thumbnails for a specific file type (e.g. uncommon proprietary files), the cloud computing service may provide a generic icon thumbnail to the e-mail server or client computer. For other types of links, such as links to online maps or videos, the cloud computing service may capture a preview thumbnail from the linked URL and send the thumbnails to the server. The e-mail server or client computer may obtain preview thumbnails for certain file types from other services in lieu of the cloud computing service. Preview thumbnails may be formatted in .gif, .jpg, or other known image formats. The preview thumbnails have a uniform appearance, such as having uniform dimensions, spacing, fonts, colors, borders, descriptions, and the like.

The e-mail message and the preview thumbnails for each attachment are displayed on the client computer, illustrated at 706. The user interface for displaying the e-mail message may be displayed on a web browser on the client computer. All the attachments to the e-mail message are shown in the same area of the user interface, such as an attachment section or card at the bottom of the e-mail message display. The preview thumbnails for all attachments are displayed uniformly such that there no visual differences between attachments that are local file attachments and linked file attachments. The user interface may provide a number of options for each attachment, such as saving the file to a cloud computing service, downloading the file, and previewing the file. The preview thumbnails may be cached for quick reference in the future. Thus method 700 illustrates a method for providing a uniform display of attachments in an e-mail message.

It will be apparent that aspects of the systems and methods described herein may be implemented in many different forms of software, firmware, and hardware in the implementations illustrated in the drawings. The actual software code or specialized control hardware used to implement aspects consistent with the principles of the systems and method described herein is not limiting. Thus, the operation and behavior of the aspects of the systems and methods were described without reference to the specific software code—it being understood that one of ordinary skill in the art would be able to design software and control hardware to implement the aspects based on the description herein.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

What is claimed is:

1. A method for providing a display of attachments for an e-mail message, the method comprising:
receiving an e-mail message with a plurality of attachments at a server, wherein a first attachment in the plurality of attachments is a file and a second attachment in the plurality of attachments is a link to a file provided by a third party service;
sending a request to a thumbnail generation service to generate a preview thumbnail for each of the plurality of attachments;
receiving from the thumbnail generation service the preview thumbnails for each of the plurality of attachments, wherein the preview thumbnail for each of the plurality of attachments have a uniform appearance; and
sending the e-mail message and the preview thumbnails for the plurality of attachments to a client computer for display.

2. The method of claim 1, wherein the third party service is a cloud computing service.

3. The method of claim 1, wherein the thumbnail generation service is a cloud computing service.

4. The method of claim 3, wherein sending the request includes sending information identifying the second attachment and the recipient to the cloud computing service.

5. The method of claim 1, wherein sending the request includes sending a copy of the first attachment to the thumbnail generation service.

6. The method of claim 1, wherein the preview thumbnails of each of the plurality of attachments have at least one of the same dimensions, the same border, the same tint, the same spacing between preview thumbnails, and same accompanying font.

7. The method of claim 1, wherein the server provides the client computer with a user interface for viewing the e-mail message and the preview thumbnails for the plurality of attachments.

8. The method of claim 7, wherein the preview thumbnails are displayed uniformly in an attachment section within the user interface.

9. The method of claim 7, wherein the user interface provides a plurality of options for each of the plurality of attachments.

10. The method of claim 9, wherein a first option in the plurality of options is selected from the group consisting of an open option, a download option, a preview option, an option to save to a cloud computing service, a share option, a play option, a forward option, and a print option.

11. A method for displaying attachments for an e-mail message, the method comprising:
receiving an e-mail message with a plurality of attachments at a client computer, wherein a first attachment in the plurality of attachments is a file and a second attachment in the plurality of attachments is a link to a file provided by a third party service;
receiving a preview thumbnail for each of the plurality of attachments, wherein the preview thumbnails are generated by a thumbnail generation service and wherein the preview thumbnail for each of the plurality of attachments have a uniform appearance; and
displaying the e-mail message and the preview thumbnails of the plurality of attachments to a recipient on the client computer.

12. The method of claim 11, wherein the third party service is a cloud computing service.

13. The method of claim 11, the method further comprising:
sending a request to the thumbnail generation service to generate the preview thumbnail for each of the plurality of attachments after receiving the e-mail message and plurality of attachments.

14. The method of claim 13, wherein sending the request includes sending information identifying the second attachment and the recipient to the thumbnail generation service.

15. The method of claim 13, wherein sending the request includes sending a copy of the first attachment to the thumbnail generation service.

16. The method of claim 11, wherein the thumbnail generation service is a cloud computing service.

17. The method of claim 11, wherein the preview thumbnails of each of the plurality of attachments have at least one of the same dimensions, the same border, the same tint, the same spacing between preview thumbnails, and same accompanying font.

18. The method of claim 11, wherein the client computer has a user interface for viewing the e-mail message and the preview thumbnails for the plurality of attachments.

19. The method of claim 18, wherein the preview thumbnails are displayed uniformly in an attachment section within the user interface.

20. The method of claim 18, wherein the user interface provides a plurality of options for each of the plurality of attachments.

21. The method of claim 20, wherein a first option in the plurality of options is selected from the group consisting of an open option, a download option, a preview option, an option to save to a cloud computing service, a share option, a play option, a forward option, and a print option.

22. A graphical user interface for displaying attachments for an e-mail message, the graphical user display comprising:
an e-mail message display for displaying the content of an e-mail message; and
an attachment preview area within the e-mail message display for displaying a plurality of preview thumbnails for a plurality of attachments in the e-mail message, wherein
a first attachment in the plurality of attachments is a file;
a second attachment in the plurality of attachments is a link to a file provided by a third party service; and
the plurality of preview thumbnails are generated by a thumbnail generation service and are displayed uniformly in the attachment preview area.

23. The graphical user interface of claim 22, wherein each of the plurality of preview thumbnails have at least one of the same dimensions, the same border, the same tint, the same spacing between preview thumbnails, and same accompanying font.

24. The graphical user interface of claim 22, wherein the preview thumbnails are arranged horizontally across the attachment preview area.

25. The graphical user interface of claim 22, wherein an options menu is provided for each of the plurality of attachments.

26. The graphical user interface of claim 25, wherein the options menu is a drop-down menu selectable by a user.

27. The graphical user interface of claim 25, wherein a first option in the options menu is selected from the group consisting of an open option, a download option, a preview option, an option to save to a cloud computing service, a share option, a play option, a forward option, and a print option.

28. The graphical user interface of claim 22, wherein the e-mail message display is configured to be displayed on a web browser.

29. The graphical user interface of claim 22, wherein the e-mail message display is viewed by a recipient of the e-mail message.

30. The graphical user interface of claim 22, wherein the e-mail message display is viewed by a sender during composition of the e-mail message.

31. The graphical user interface of claim 22, wherein the thumbnail generation service is a cloud computing service.

32. The graphical user interface of claim 22, wherein the third party service is a cloud computing service.

33. A system for providing a display of attachments for an e-mail message, the system comprising:
a computing device configured to:
communicate with a plurality of client computers and a thumbnail generation service over a communication network;
receive an e-mail message with a plurality of attachments from a first client computer in the plurality of client computers, wherein a first attachment in the plurality of attachments is a file and a second attachment in the plurality of attachments is a link to a file provided by a third party service;
send a request to the thumbnail generation service to generate a preview thumbnail for each of the plurality of attachments;
receive from the thumbnail generation service the preview thumbnails for each of the plurality of attachments, wherein the preview thumbnail for each of the plurality of attachments have a uniform appearance; and
render the e-mail message and the preview thumbnails for the plurality of attachments for display.

34. The system of claim 33, wherein the thumbnail generation service is a cloud computing service.

35. The system of claim 33, wherein the third party service is a cloud computing service.
